(19) United States
(12) Patent Application Publication
(10) Pub. No.: US 2025/0365316 A1
(43) Pub. Date: Nov. 27, 2025

(54) NETWORK TRANSACTION MANAGEMENT

(71) Applicant: Honeywell International Inc., Charlotte, NC (US)

(72) Inventor: Anand Kutuva Arjunan, Karnataka (IN)

(21) Appl. No.: 18/669,594

(22) Filed: May 21, 2024

(51) Int. Cl. H04L 9/40

(52) U.S. Cl. CPC H04L 63/20; H04L 63/083

(57) ABSTRACT

Techniques for managing network transactions are disclosed. An attribute associated with data to be communicated to one of the first and the second set of nodes in a subsequent transaction is determined. The attribute is then translated into a divisible form made of discretized elements. One or more discretized elements are then determined from amongst the discretized elements, where each determined discretized element identifies a portion of the data. A portion identification signal is then generated based on the determined discretized elements to identify portions of the data. Further, the portion identification signal triggers association of a digital credential with each of the identified portions. An authentication status is then determined for each of the identified portions based on the digital credential associated therewith. Based on the authentication status, occurrence of the transaction may be permitted between the first set of nodes and the second set of nodes.

### BACKGROUND

In a computing environment, there may be multiple interconnected networks. Multiple networks, or devices therein, generally communicate with each other to exchange information and other data. The computing environment typically includes one or more network nodes, such as a gateway, that interconnects different networks. In one example of an avionics computing environment, an aircraft may have the gateway associated therewith. The gateway may interconnect avionics systems of the aircraft with one or more aircraft services that may be located on the ground. The gateway device may act as an endpoint for any avionics request being received from external domains, such as the one or more aircraft services. Thus, in a computing environment having a network of networks, some of the computing nodes, for example, the gateway devices, are responsible for securing one network against any threat coming in from another network.

### BRIEF DESCRIPTION OF DRAWINGS

The detailed description is described with reference to the accompanying figures. It should be noted that the description and figures are merely examples of the present subject matter and are not meant to represent the subject matter itself.

FIGS. 1A to 1C illustrate a computing environment comprising a system, according to an example implementation.

FIG. 2 illustrates a block diagram of the system, according to an example implementation.

FIG. 3 illustrates a computing environment comprising the system, according to another example implementation.

FIG. 4 illustrates data as textual data, according to one example implementation.

FIG. 5 illustrates the data as a set of images, according to one example implementation.

FIG. 6 illustrates the data as an image, according to one example implementation.

FIG. 7 illustrates a method for managing network transactions, according to an example implementation.

FIGS. 8A and 8B illustrate the method for managing the network transactions, according to another example implementation.

FIG. 9 illustrates a non-transitory computer-readable medium for controlling transactions within a network with enhanced security, in accordance with an example of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A computing environment may include a network of networks. For instance, the network may be communicably connected with one or more other networks. Each of the networks may have one or more nodes located therein. Examples of such nodes may include, but are not limited to, servers, communication systems, computing systems, user equipment, monitoring and security systems, and safety systems. The nodes located within different networks may communicate with each other to exchange data and information therebetween.

Generally, different networks may have one or more different properties. For example, each of the networks may have different operating domains. Thus, the networks may include one or more devices or systems that may facilitate communication between the networks. For example, a gateway may communicably connect a network with another network which is external to the network. Also, the gateway may serve as an entry and exit point for the network as all data and/or communication generally passes through the gateway before being routed to other nodes located within the network. For example, the gateway may be associated with the network linked with a financial organization, such as a bank. The gateway may communicably connect the network linked with the financial organization with an external network or domain. The gateway may act as an endpoint for requests coming in from the external domain, for example, customers of the bank. Thus, the gateway may enable one network to communicate with another network.

The gateway(s) may also be utilized for securing the network against incoming threats from external networks. For example, the gateways may be configured to allow communication only when one or more requirements or conditions are satisfied by an incoming request. In case the incoming request fails to comply with such requirements or conditions, the gateway may restrict communication between the networks and the request may not be further routed to the nodes located within the network. The network may thus be secured from possible threats from external networks. Similarly, other devices or systems may also be utilized to enable communication and security between different networks. Thus, an environment, having the network of networks, may generally include devices or systems that enable communication between the networks and are also responsible for securing one network against any threat coming in from another network.

With advancements in technology, various solutions have been developed for securing the network from threats from external networks. Such security solutions imply robust security measures, however, they have adverse effects on the overall performance of computing resources and/or the gateway. Examples of such security solutions may include intrusive and non-intrusive approaches. In an intrusive approach, the gateway is required to validate all the contents of the data being received from the external networks and ensure that the contents comply with necessary requirements or policies. The gateway is thus required to perform an extensive validation analysis for all the data packets that the gateway handles or receives from the external network. Also, it is extremely strenuous for the gateway to validate every data packet received and then route them accordingly to a corresponding node or device in the network. Thus, the conventional intrusive approach significantly affects the performance and efficiency of the gateway, and the system in which the gateway may be deployed. Further, since validation analysis is required to be performed for all the content or data packets, a significant amount of computing resources, such as processing capacity, may eventually be required. Also, since validation analysis is required to be performed for all the data packets, the total time required to allow communication or transfer of the data packets increases. As a result, communication or transfer of data between networks may be delayed, and the delay may increase with an increase in the amount or size of the data packets.

In another example of the non-intrusive approach, every data packet is digitally signed and sent to the gateway. The gateway then verifies the digital signature associated with each of the data packets to ensure integrity of each data packet received from the external network. However, verifying the digital signatures associated with each of the data packets would also be strenuous for the gateway and would, thus eventually affect the performance and efficiency of the gateway and the system in which the gateway may be deployed. Additionally, generation of digital signatures for all data packets is required, thereby introducing additional strain on the gateway, or the system in which the gateway may be deployed. Further, if the signing key is compromised, the non-intrusive approach may fail to safeguard the network from external threats. Any component having the signing key would be able to digitally sign and send malicious data packets. Thus, the conventional approaches compromise the performance of the gateway, and eventually, the system in which the gateway may be deployed. Also, in the conventional approaches, the security of the network may be compromised if the key is lost.

The present subject matter describes approaches for efficient network transaction management with enhanced security. According to one example implementation of the present subject matter, an occurrence of a subsequent transaction may be predicted. In one example, the prediction may be in response to the occurrence of a transaction between a first set of nodes and a second set of nodes. Thus, the subsequent transaction may be a transaction that is yet to occur between the first and the second set of nodes. The first set of nodes and the second set of nodes may be associated with different networks. The first and the second set of nodes may include, for example, one or more servers, communication devices, computing devices, user equipment, monitoring and security devices, safety systems, and a combination thereof. Further, in one example, a transaction may be any communication between the first and the second set of nodes. The communication may be, for example, to exchange data. For instance, the first set of nodes, or any device associated therewith, may share data with the second set of nodes, or any device associated therewith. Such an exchange of data may be referred to as a transaction, in one example, between the first and the second set of nodes.

Further, upon predicting the subsequent transaction, an attribute associated with data linked with the subsequent transaction may be determined. The data may be, for example, data packets to be exchanged between the first and the second set of nodes. For instance, the data may be data packets to be transferred from the first set of nodes to the second set of nodes. Since the subsequent transaction may be a transaction that is yet to occur between the first and the second set of nodes, the data may also be the data that is yet to be communicated in the subsequent transaction. Thus, in one example, the attribute associated with the data may be determined upon predicting the subsequent transaction. The attribute may be, in one example, a total size of the data that is yet to be communicated, say, from the first set of nodes to the second set of nodes.

The attribute may then be translated into a divisible form made of a plurality of discretized elements that collectively represent the attribute. For example, the divisible form may be a numerical value representing the total size of the data and the plurality of discretized elements may be numbers that collectively represent the total size of the data. In an example, for data having an attribute as a total number of frames, say 100, in a set of images that are to be communicated from the first set of nodes to the second set of nodes. The divisible form may be determined as 100, and the plurality of discretized elements may be frames 1^{st}, 2^{nd}, 3^{rd}, . . . 100^{th} frame, thus collectively representing the divisible form 100. Further, each of the plurality of discretized elements may identify a portion of the data. For example, the discretized element 1 may identify the 1^{st} frame.

Further, one or more discretized elements may then be determined from amongst the plurality of discretized elements. In one example, the one or more discretized elements may be determined based on a random selection mechanism. For example, one or more discretized elements may be randomly selected to randomly select ranges of the data. For instance, frames falling within a randomly selected range of 1 to 20 and 65 to 90 may be determined. Thus, the randomly selected range of 1 to 20 and 65 to 90 may be indicative of portions of data.

A portion identification signal may then be generated based on the one or more discretized elements to identify one or more portions of the data to be communicated to at least one of the first set of nodes and the second set of nodes. In one example, the portion identification signal may indicate the randomly selected range of 1 to 20 and 65 to 90 frames. Thus, the portion identification signal may identify the one or more identified portions of the data, for example, the range of frames.

Further, the portion identification signal may trigger association of a digital credential with each of the one or more identified portions of the data yet to be communicated. In one example, the digital credential may be a digital certificate. The digital credential may be associated with each of the one or more identified portions of the data. In one example, each of the one or more identified portions of the data may have a unique digital certificate associated therewith. In another example, same digital certificate may be associated with each of the one or more identified portions of the data.

An authentication status may then be determined for each of the one or more identified portions of the data based on the digital credential associated therewith. In one example, the digital credential associated with each of the one or more identified portions of the data may be verified through a public key cryptography process. For example, the digital certificate's public key may be included within the digital certificate itself and may be used to verify the authenticity of the portion of data. Based on the verification of the digital certificate or credential, the authentication status may then be determined for each of the one or more identified portions of the data.

In one example, the authentication status may indicate whether each of the one or more identified portions of the data complies with a data integrity requirement. For example, if the digital certificate associated with each of the one or more identified portions of the data is determined to be authentic, the authentication status may indicate that each of the one or more identified portions of the data is authentic and/or is received from a recognized source. Based on the authentication status of each of the one or more identified portions of the data, the occurrence of the subsequent transaction between at least one of the first set of nodes and the second set of nodes may be permitted. For example, if the digital credentials associated with the one or more identified portions of the data are determined to be authentic, communication of the data associated with the subsequent transaction may be permitted. For instance, communication of the data may be permitted from the first set of nodes to the second set of nodes. However, if the digital credentials associated with the one or more identified portions of the data are determined to be in non-compliance with the data integrity requirement, the occurrence of the subsequent communication may be restricted. For instance, the data associated with the subsequent transaction may not be transferred from the first set of nodes to the second set of nodes.

The present subject matter may address the problems associated with conventional techniques. For example, by randomly selecting the discretized elements, that identifies the portions of data with which the digital credentials are to be associated, it may become impossible, or at least extremely difficult, to predict the portions of the data that have digital credentials associated therewith. Thus, it may become extremely difficult for any external or unauthorized entity, for example, a hacker, to determine the portions of data and thereby the digital credentials being used for securing the portions of data. Therefore, security of the digital credentials and thereby the data is enhanced.

Further, as only portions of data are to be associated with digital credentials, there is no requirement to generate digital credentials for all portion or packets of data. Also, at the time of authentication, a reduced number of digital credentials are to be processed and/or verified to determine the authenticity of the data. Thus, processing load on computing resources is reduced. Further, as only portions of data associated with digital credentials are to be verified, and not all of the data, time required for verifying the complete data may be significantly reduced. Thus, the verification process for the data may be expedited. The present subject matter thus provides a balanced approach between performance and security. By randomly selecting the portions of data, associating digital credentials with the selected portions of data, and verifying only such portions of data, the present subject matter thus provides approaches for efficient network transaction management with enhanced security.

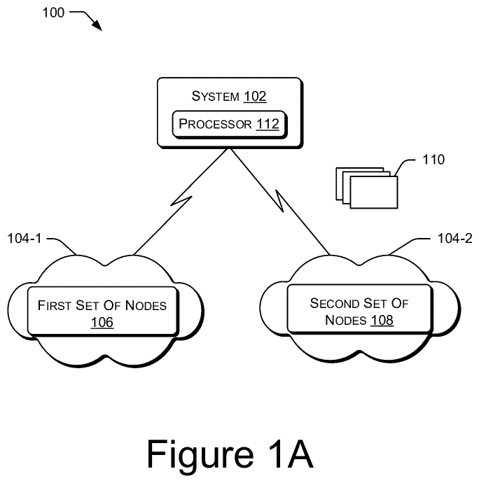

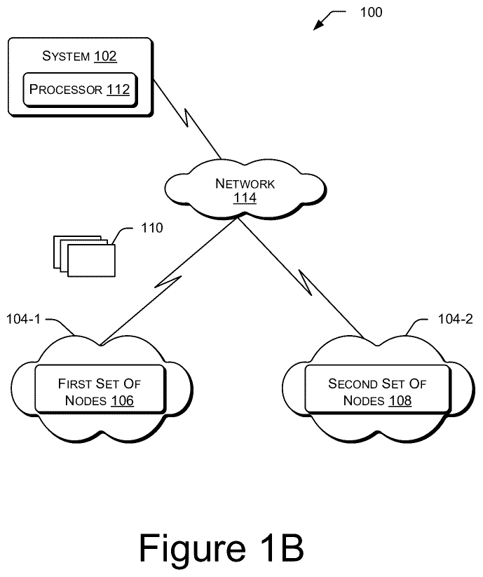

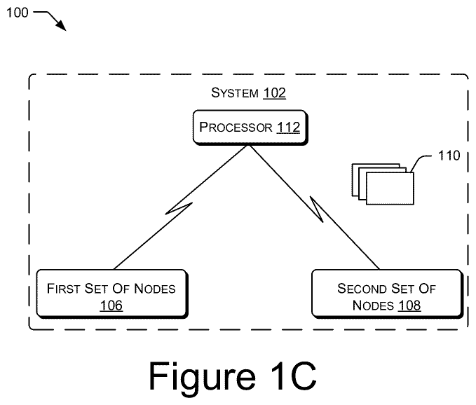

The above techniques are further described with reference to FIGS. 1A to 9. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIGS. 1A to 1C illustrate a computing environment 100 comprising a system 102, according to an example implementation. FIGS. 1A to 1C may be discussed in conjunction with each other. In one example, the computing environment 100 may be any environment having multiple networks. For example, the computing environment 100 may include a first network 104-1 and a second network 104-2. In one example, the first network 104-1 and the second network 104-2 may be communicably coupled with each other via the system 102, as illustrated in FIG. 1A. For explanation purposes, only two networks have been illustrated, however, there may exist more networks that may be interconnected via the system 102.

In one example, each of the first network 104-1 and the second network 104-2 may include one or more devices or nodes associated therewith. For example, the first network 104-1 may include a first set of nodes 106 and the second network 104-2 may include a second set of nodes 108. The first set of nodes 106 and the second set of nodes 108 may be, in one example, one or more hardware devices associated with the first network 104-1 and the second network 104-2, respectively. Examples of the first set of nodes 106 and the second set of nodes 108 may include, but are not limited to, servers, communication devices, computing devices, user equipment, monitoring devices, and security devices. In another example, each of the first set of nodes 106 and the second set of nodes 108 may include software applications or services-based nodes. For example, the first set of nodes 106 and the second set of nodes 108 may include one or more software applications or services. In another example, the first set of nodes 106 and the second set of nodes 108 may include a combination of one or more software applications or services and one or more hardware devices. In yet another example, each of the first set of nodes 106 and the second set of nodes 108 may include one or more virtual instances of one or more devices or applications being hosted on one or more hardware devices. Further, other combinations of hardware and software instances may also be possible for the first set of nodes 106 and the second set of nodes 108. In one example, the first set of nodes 106 and the second set of nodes 108 may only include one or more applications or software-based modules that may be hosted on a device that may be associated with another network different from the first and the second networks.

In one example, the computing environment 100 may be an aircraft service-related computing environment where the first network 104-1 may be a network associated with an aircraft having the first set of nodes 106 linked therewith. Examples of the first set of nodes 106 may include, but are not limited to, Flight Management Systems (FMS), Onboard Management Systems (OMS), and Avionics systems. Further, the second network 104-2 may be a network associated with aircraft-related services having the second set of nodes 108 linked therewith. Examples of the second set of nodes 108 may include, but are not limited to, systems and/or devices related to aircraft services, ground clients, navigation systems, communication systems, systems and/or devices related to Air Traffic Control (ATC), and other connected applications. In one example, the system 102 may be a gateway, and the first set of nodes 106 and the system 102 may be located on the aircraft.

In another example, the computing environment 100 may be a financial service-related computing environment where the first network 104-1 may be a network associated with a financial organization, such as a bank, having the first set of nodes 106 linked therewith. Examples of the first set of nodes 106 may include, but are not limited to, Customer Relationship Management (CRM) systems, payment gateway systems and/or applications, systems and/or devices related to Internet banking, data repositories or storage nodes, and systems and/or devices related to security services. Further, the second network 104-2 may be a network external to the first network 104-1. For example, the second network 104-2 may be a network associated with a user accessing, or trying to access, platform and/or services associated with the financial organization. The second set of nodes 108 may include devices, applications, and/or systems associated with the second network 104-2. Examples of the second set of nodes 108 may include, but are not limited to, user equipment, an access point, a web application, and a mobile application.

In yet another example, the computing environment 100 may be an Over-The-Top (OTT) service-related computing environment where the first network 104-1 may be a customer's network accessing, or intending to access, services being offered by an OTT service provider. For example, the first network 104-1 may have the first set of nodes 106, such as a user equipment, for accessing content being provided by the OTT service provider. Further, the second network 104-2 may be a Content Delivery Network (CDN) associated with the OTT service provider having the second set of nodes 108. The second network 104-2 may include the second set of nodes 108. The second set of nodes 108 may include, for example, one or more caching servers and content delivery controllers.

In yet another example, the computing environment 100 may be a computing environment where the first network 104-1 may be a network associated with an Internet Service Provider (ISP) and formed by the first set of nodes 106. Further, the second network 104-2 may be any known type of network formed by the second set of nodes 108. Examples of the known type of network may include, but are not limited to, Personal Area Network (PAN), Local Area Network (LAN), Metropolitan Area Network (MAN), and Wide Area Network (WAN).

The above-discussed examples are only for illustration purposes and should not be considered as limiting in nature and scope. For example, the first and the second networks may be associated with the same network. In another example, the first and the second networks may be a part of another network. In another example, the first and the second networks may be any of PAN, LAN, WAN, and MAN. In yet another example, the first and the second networks may be a combination of any known type of network, such as PAN, LAN, WAN, and MAN.

Further, in one example, the first network 104-1 and the second network 104-2 may be associated with different network domains. For example, the first network 104-1 may be associated with a first network domain and the second network 104-2 may be associated with a second network domain, that may be different than the first network domain. In another example, the first network 104-1 and the second network 104-2 may be associated with sub-domains of same network domain. Further, the first network 104-1 and the second network 104-2 may follow either same or different set of protocols.

Further, in one example, the first and the second set of nodes may not be associated with any specific network, such as the first and the second network, respectively. The first and the second set of nodes may form their own respective networks. For example, each of the first and the second set of nodes may include interconnected devices and/or applications that may themselves form a network. For instance, the first set of nodes 106 may form the first network 104-1 and the second set of nodes 108 may form the second network 104-2. Other obvious architectures may also be possible.

As illustrated in FIG. 1A, the first set of nodes 106 and the second set of nodes 108 may be communicably coupled with each other via the system 102. The system 102 may be communicably coupled with first set of nodes 106 and the second set of nodes 108 to manage network transactions between the first and the second set of nodes. In one example, the system 102 may be a set of devices, having one or more devices, capable of managing and facilitating network transactions. For example, the system 102 may be a gateway that may manage and enable communication between the first and the second set of nodes. In another example, the system 102 may be a combination of one or more devices and software-based applications configured to manage and facilitate network transactions.

In one example, the system 102 may enable, or at least assist in enabling, exchange of data 110 between the networks with which it is communicably coupled. In one example, the system 102 may include a processor 112 for managing the network transaction occurring, or going to occur, between the networks or the first and the second set of nodes, as will be discussed. For example, the processor 112 may manage and/or control the exchange of data 110 between the first and the second set of nodes. For example, the system 102 may receive data 110 from the second set of nodes 108, and manage forwarding of the data 110 to the first set of nodes 106, and vice versa. In one example, the system 102 may additionally be configured to control transfer of data 110 between the first and the second set of nodes to enhance security, as will be discussed.

Though it has been illustrated, by way of an example in FIG. 1A, that the first and the second networks are in direct communication with each other via the system 102 to exchange data 110 and signals, other configurations and/or architectures may also be possible. For example, the system 102, the first network 104-1, and the second network 104-2 may be communicably coupled with each other through another network 114, as illustrated in FIG. 1B, and may exchange data 110 and signals over the network 114. For instance, the system 102, the first network 104-1, and the second network 104-2 may be distributed across different locations and/or platforms and may be communicably coupled over the network 114 to assist in inter-communications. Examples of the first network 104-1, the second network 104-2, and the network 114 may include, but are not limited to LAN, WAN, the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the first network 104-1, the second network 104-2, and the network 114 may include various network entities, such as transceivers, gateways, and routers. In an example, the first network 104-1, the second network 104-2, and the network 114 may include any communication network that uses any of the commonly used protocols, for example, Hypertext Transfer Protocol (HTTP), and Transmission Control Protocol/Internet Protocol (TCP/IP).

Further, though illustrated that the first network 104-1 and the second network 104-2 are communicably coupled with the system 102 and are external to the system 102, other architectures and implementations may also be possible. In one example, the first network 104-1 and the second network 104-2 may be a part of the system 102. In another example, the system 102 may include the first set of nodes 106 and the second set of nodes 108 communicably coupled with each other, as illustrated in FIG. 1C. Thus, the first set of nodes 106 and the second set of nodes 108 may not be a part of any network and may be communicably coupled with the each other via the processor 102 of the system 102.

Different architectures and examples have been discussed above. However, such examples and illustrations are not to be considered as limiting in nature and scope. Other obvious architectures may also be possible where at least two set of nodes, each having one or more devices and/or applications, may be communicably connected to exchange data and signals.

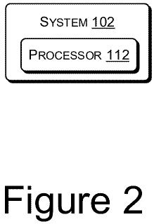

FIG. 2 illustrates a block diagram of the system 102, according to one example implementation of the present subject matter. FIG. 2 will be discussed in conjunction with FIGS. 1A to 1C. In one example, the system 102 may assist in network traffic management between entities, devices, and/or applications with enhanced security.

In one example, the system 102 may include the processor 112 configured to assist in network traffic management with enhanced security. In one example operation, the processor 112 may determine an attribute associated with data to be communicated to at least one of the first set of nodes 106 and the second set of nodes 108. For example, the processor 112 may determine the attribute in response to an occurrence of a transaction between the first set of nodes 106 and the second set of nodes 108. The transaction may be, in one example, a transfer of data and/or signals from the second set of nodes 108 to the first set of nodes 106. In response to the occurrence of the transaction, the processor 112 may determine the attribute associated with data that is yet to be communicated, for instance, in a subsequent transaction. The subsequent transaction, in one example, may be another transaction that is yet to occur, between the first set of nodes 106 and the second set of nodes 108, following the transaction that has recently occurred between the first set of nodes 106 and the second set of nodes 108.

In one example, the processor 112 may be configured to predict transactions. For example, the processor 112 may be configured with data sets indicating transactions that may have possibly occurred between the first set of nodes 106 and the second set of nodes 108 and the attribute associated with data involved in such transactions. The attribute may be, for example, a property associated with the data. For instance, the attribute may be a size or type of data that is sent from the second set of nodes 108 to the first set of nodes 106. Additionally, the processor 112 may be configured with data sets indicating a pattern in which the transactions may have possibly occurred between the first set of nodes 106 and the second set of nodes 108. Thus, by utilizing such a data set indicating all, or most of, the possible transactions, attributes associated therewith, and a pattern in which the transactions are generally likely to occur, the processor 112 may be configured with capabilities to predict the subsequent transactions that may occur. Accordingly, the processor 112 may also be able to predict the attribute associated with the subsequent transaction.

Thus, in one example, the processor 112 may predict occurrence of the subsequent transaction in response to occurrence of the transaction between the first set of nodes 106 and the second set of nodes 108. Further, upon predicting the subsequent transaction, the processor 112 may determine the attribute associated with data linked with the subsequent transaction. In one example, if the data that is yet to be exchanged is a set of images, the attribute may be a total number of images that is yet to be communicated in the subsequent transaction, say, from the second set of nodes 108 to the first set of nodes 106.

The processor 112 may then translate the attribute into a divisible form made of a plurality of discretized elements that collectively represent the attribute. For example, the divisible form may be a numerical value representing the total number of images and the plurality of discretized elements may be each of the individual numbers, collectively representing the total number of frames. In an example, the data may be a set of images to be communicated in the subsequent transaction from the second set of nodes 108 to the first set of nodes 106. The set of images may include 150 serially linked images. The processor 112 may determine, for example, the attribute as 150 images, indicating a combination of size and property of the data. The processor 112 may then translate the attribute into divisible form, say 150 or any other numerical equivalent that may be determined by the processor 112 based property of the data. For example, consider the divisible form of the attribute is determined to be the number “150”, indicating the number of images in the set of images. The plurality of discretized elements may then be the 1, 2, . . . 150, thus collectively representing the divisible form “150”.

Further, the processor 112 may determine one or more discretized elements from amongst the plurality of discretized elements. The processor 112 may, in one example, implement a random select mechanism that may randomly determine one or more discretized elements from amongst the plurality of discretized elements. For example, by implementing the random selection mechanism, the processor 112 may randomly determine one or more numbers from amongst the plurality of discretized elements. For instance, the processor 112 may determine the 1, 10 to 50, and 65 from the plurality of discretized elements.

Further, the processor 112 may generate, in one example, a portion identification signal based on the one or more discretized elements to identify one or more portions of the data which is yet to be communicated to at least one of the first set of nodes 106 and the second set of nodes 108.

In one example, each of the plurality of discretized elements may identify a portion of the data. For example, the discretized element 1 may identify the 1^{st} image from among the set of images. Similarly, there may be 150 discretized elements, each identifying or indicating a corresponding image from the set of 150 images. The randomly selected discretized elements 1^{st}, 10^{th} to 50^{th}, and 65^{th} may therefore identify the 1^{st} image, images 10^{th} to 50^{th}, and 65^{th} image from among the set of 150 images that are yet to be communicated in the subsequent transaction. Accordingly, the processor 112 may be configured to generate the portion identification signal that may contain information identifying the one or more portions of the data based on the determined discretized elements. For example, the processor 112 may generate the portion identification signal indicating the 1^{st} image, images 10^{th} to 50^{th}, and 65^{th} image as the identified portions from among the set of 150 images, that are yet to be communicated in the subsequent transaction to at least one of the first set of nodes 106 and the second set of nodes 108. Thus, once the one or more discretized elements are randomly determined, the processor 112 may generate the portion identification signal identifying the portions of data corresponding to the determined one or more discretized elements.

Further, by generating the portion identification signal, the processor 112 may trigger the association of a digital credential with each of the one or more identified portions of the data yet to be communicated. For example, the processor 112 may trigger a workflow that may be configured to associate a digital credential with each of the one or more identified portions of the data. In one example, the digital credential may be a digital signature. The processor 112 may cause association, for example, of a unique digital signature with each of the one or more identified portions, i.e., the identified images from amongst the set of images. In another example, the same digital certificate may be associated with each of the one or more identified images.

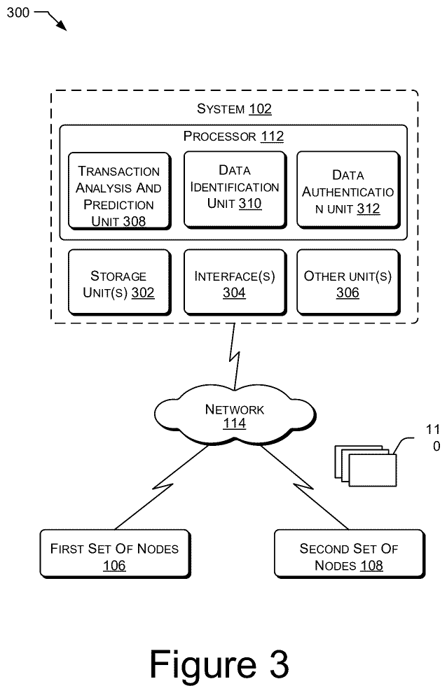

The processor 112 may then determine an authentication status for each of the one or more identified portions of the data based on the digital credential associated therewith. In one example, the digital signature associated with each of the one or more identified images may be verified through a cryptography process. Based on the verification of the digital signatures or credentials, the processor 112 may determine the authentication status for each of the one or more identified portions of the data. In one example, the authentication status may indicate whether each of the one or more identified portions of the data complies with a data integrity requirement. For example, if the digital signature associated with each of the one or more identified portions of the data is determined to indicate that the one or more identified portions are from an authentic or authorized source, being one of the data integrity requirements, the processor 112 may determine that each of the one or more identified portions of the data is genuine, being the authentication status. In one example, storage unit(s) (as illustrated in FIG. 3), communicably coupled with the processor 112, may store a list of authentic or authorized sources. Based on the list, the processor 112 determine whether each of the one or more identified portions of the data is from one of the authentic or authorized sources. Based on the determination, the processor 112 may ascertain the authentication status. For example, the processor 112 may ascertain whether the one or more identified portions of the data is genuine. In another example, the digital signature associated with each of the one or more identified portions of the data may itself include an indicator that may indicate whether the one or more identified portions are from an authentic or authorized source. Thus, the authentication status may indicate whether each of the one or more identified portions of the data is genuine.

Based on the authentication status of each of the one or more identified portions of the data, the processor 112 may determine whether the occurrence of the subsequent transaction between at least one of the first set of nodes 106 and the second set of nodes 108 is to be permitted. For example, if the digital credentials associated with the one or more identified portions of the data are determined to be genuine, the processor 112 may permit communication of the data 110 associated with the subsequent transaction. For instance, communication of the data 110 may be permitted from the second set of nodes 108 to the first set of nodes 106.

However, if the processor 112 determines that the digital credentials associated with any of the one or more identified portions fail to comply with the data integrity requirement, the processor 112 may determine an authentication status indicating the ingenuinity. The processor 112, based on the authentication status, may restrict the occurrence of the subsequent communication. For instance, the data associated with the subsequent transaction may not be transferred from the second set of nodes 108 to the first set of nodes 106.

Random selection of the discretized elements and thereby the portions of data with which the digital credentials are to be associated may make it impossible, or at least extremely difficult, to predict the portions of the data that have digital credentials associated therewith. Therefore, any external or unauthorized entity, for example, a hacker, may not be able to determine the portions of data and thereby the digital credentials being used for encrypting the data. Therefore, a two-fold enhancement in security may be observed. Firstly, the digital credentials being used for encrypting the data may remain secure. Secondly, since the digital credentials remain unknown, decryption of data may become impossible, or at least extremely challenging.

Further, as only portions of data are to be associated with digital credentials, there is no requirement to generate digital credentials for all portions of the data. Thus, a reduced number of digital credentials are required to be generated and/or associated with the data. Further, at the time of authentication, the reduced number of digital credentials are required to be processed and verified to determine the authenticity of the data. Thus, the processing load on computing resources, such as the processor 112 of the system 102, may be reduced. Further, as only portions of data associated with digital credentials are to be verified, and not all of the data, the time required for verifying the complete data may be significantly reduced. Thus, the verification process for the data may be expedited. The present subject matter thus provides a balanced approach between performance and security. By randomly selecting the portions of data, associating digital credentials with the selected portions of data, and verifying only such portions of data, the present subject matter provides approaches for efficient network transaction management with enhanced security.

FIG. 3 illustrates a computing environment 300 comprising the system 102, according to another example implementation. In one example, the computing environment 300 may be similar to the computing environment 100 discussed with reference to FIGS. 1A to 1C. The computing environment 300 may be any computing environment including one or more computing devices or systems, digital platforms, user equipment, software-based applications, or a combination thereof. The computing devices or systems, digital platforms, user equipment, or software-based applications may interchangeably be referred to as nodes in the description. The computing environment 300 may be a network of such nodes that may be communicably coupled with each other.

In one example, the computing environment 300 may be associated with an organization having communicably coupled nodes to exchange data and/or signals. In another example, the computing environment 300 may include multiple nodes that may be associated with more than one organization and may be communicably coupled with each other to exchange data and/or signals. Few examples of computing environments have been discussed with reference to FIGS. 1A to 1C. However, other examples of computing environments may also be possible where multiple nodes may be communicably coupled with each other to exchange data and/or signals.

The system 102 may be implemented in the computing environment 300 and may be communicably coupled with one or more of the nodes associated with the computing environment 300. In one example, the system 102 may facilitate the exchange of data and/or signals between the nodes of the computing environment 300. Further, the system 102 may manage, or at least assist in managing, communication of data and/or signals, i.e., network transactions between the first and second set of nodes. In one example, the system 102 may function as the gateway that may communicably couple the nodes and facilitate communication between them. For example, the system 102 may be communicably coupled with the first set of nodes 106 and the second set of nodes 108. In one example, the system 102 may be in direct communication with the first and the second set of nodes. In another example, the system 102 may be communicably coupled with the first and the second set of nodes via the network 114, as also illustrated in FIG. 1B.

Further, in one example, each of the first set of nodes 106 and the second set of nodes 108 may be associated with a same network. For example, the first and the second set of nodes may be associated with a first organization and may be located on the same network. The organization may utilize the system 102, in one example, for managing network transaction and enhancing security, as discussed above and will be discussed below. However, in another example, the first set of nodes 106 may be associated with the first network 104-1 and the second set of nodes 108 may be associated with the second network 104-2, separate from the first network 104-1, as discussed with reference to FIGS. 1A to 1C. For example, the first set of nodes 106 may be associated with a first organization (not shown) and the second set of nodes 108 may be associated with a second organization (not shown). For instance, the first set of nodes 106 may be associated with the aircraft's network and the second set of nodes 108 may be associated with the aircraft-related ground service's network. In another example, the first set of nodes 106 may be associated with a customer's network and the second set of nodes 108 may be associated with an OTT service provider's network. Few other examples have also been discussed with reference to FIGS. 1A to 1C. Other examples, where communication may occur between two nodes may also be possible. In such examples, the system 102 may be communicably coupled with the first set of nodes 106 and the second set of nodes to facilitate communication of data and/or signals therebetween.

The system 102 may either be managed by an organization or an external entity, for example, a third-party organization designated for managing the system 102. For example, the system 102 may be implemented as a combination of hardware and software components that may be managed and hosted either by the organization itself or by the third-party organization. In another example, the system 102 may be offered as a platform or service and may be assessed by one or more organizations or users willing to manage network transactions. For example, the system 102 may be offered as a Platform as a Service (PaaS) or Software as a Service (SaaS) for assisting in efficiently managing network transactions and enhancing. For example, the system 102 may be hosted on a cloud-based platform and may be accessed by organizations, or individuals. In another example, the system 102 may associated with a platform that may assist in the management of network transactions. The platform may be used by one or more users, collectively by a group of users, and by organizations or individuals associated therewith. Further, in one example, the system 102 may be implemented as a user assistance platform, or at least a part thereof, that may be utilized by a common audience or users for efficiently managing network transactions. The common users may include a general audience, for example, any user having the intent to manage network transactions.

Thus, the system 102 may function, in one example, as the gateway being communicably coupled with nodes of any computing environment where the network transactions, or network-related transactions, are required to be facilitated and managed. In one example, the system 102 may include the processor 112. The processor 112 may be configured to, in one example, assist in facilitating and management of network transactions with enhanced security. The processor 112 may be implemented as a dedicated processor, a shared processor, or a plurality of individual processors, some of which may be shared. Examples of the processor 112 may include, but are not limited to, microprocessors, microcomputers, microcontrollers, digital signal processors, central processing units, state machines, Artificial Intelligence (AI) based processors, machine learning based processors, deep learning based processors, a system on chip (SOC), processing circuitries including one or more modules or engines, and/or any other devices that manipulate signals and data based on computer-readable instructions, and/or any other devices.

In one example, the system 102 may further include storage unit(s) 302, interface(s) 304, and other unit(s) 306. The storage unit(s) 302 may be configured to optionally store data and/or signals. For example, the storage unit(s) 302 may store data associated with the nodes communicably coupled with the system 102. The storage unit(s) 302 may also store log records indicating the communication of data, such as the data 110, between the nodes. The storage unit(s) 302 may also store information associated with successful and failed network transactions between the nodes determining faults and performance of the nodes, the system 102, and/or network, such as the networks 104-1, 104-2, and/or 114. Thus, the storage unit(s) 302 may be configured to function as a data repository. The storage unit(s) 302 may include one or more physical storage devices, one or more virtual storage being implemented on the physical storage devices, or a combination thereof. In one example, the storage unit(s) 302 may implement distributed data storage techniques. For example, the data and/or signals may be stored in a distributed manner across different storage units. Also, in one example, the data and/or signals may be replicated on multiple storage units. Distribution and data replication may enhance fault tolerance against loss of data, for example, due to failure or loss of connection with any of the storage units. Further, in one example, the storage unit(s) 302 may be located at different locations and may be communicably coupled with each other. The storage unit(s) 302, in one example, may also have different properties. For example, some of the storage units may have high-speed read/write capabilities as compared to the other data storage units. The storage unit(s) 302 may dynamically enable read and write operations at varying speeds based on different conditions, for example, the size of data to be read and written data from/to the storage unit(s) 302.

Further, the interface(s) 304 may allow communicably coupling the system 102, and/or the processor 112, with one or more other entities, such as the storage unit(s) 302, the first set of nodes 106, and the second set of nodes 108, and the network, such as the networks 104-1, 104-2, and/or 114. The connection or coupling may be through a wired connection or a wireless connection. The interface(s) 304 may also enable intercommunication between different logical as well as hardware components of the system 102.

The other unit(s) 306 may include, in one example, a power supply unit (not shown) and a communication unit (not shown). The power supply unit may, for example, manage distribution or supply of electrical current within the system 102 for functioning of the system 102. Further, the communication unit may be, in one example, a wireless communication unit. Examples of the communication unit may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication unit may also include one or more antennas to enable wireless transmission and reception of data and signals. The communication unit may allow the system 102 to be communicably coupled with networks such as the networks 104-1, 104-2, and/or 114. Also, the communication unit may allow the system 102 to transmit and receive data and signals to and from one or more other nodes, such as the first set of nodes 106, the second set of nodes 108, and the storage unit(s) 302.

As illustrated, in one example, the first set of nodes 106 and the second set of nodes 108 may be communicably coupled with each other via the system 102. The system 102 may be communicably coupled to manage and facilitate network transactions between the first set of nodes 106 and the second set of nodes 108. In one example, the system 102 may include the processor 112 for facilitating and managing the network transactions occurring, or going to occur, between the networks or the first and the second set of nodes, as will be discussed. For example, the processor 112 may manage and/or control the exchange of data 110 between the first and the second set of nodes. For example, the processor 112 may receive data 110 from the second set of nodes 108, and manage forwarding of the data 110 to the first set of nodes 106, and vice versa. In one example, the processor 112 may additionally be configured to control transfer of data 110 between the first and the second set of nodes to enhance security, as will be discussed.

In one example operation, the processor 112 may determine the attribute associated with data, such as the data 110, that is yet to be communicated to at least one of the first set of nodes 106 and the second set of nodes 108. In one example, the processor 112 may determine the attribute in response to occurrence of a transaction between the first set of nodes 106 and the second set of nodes 108. The transaction may be, in one example, the transfer of data from the second set of nodes 108 to the first set of nodes 106. Thus, in response to determining occurrence of the transaction, the processor 112 may be configured to determine the attribute associated with the data 110 that is yet to be communicated, for instance, in a subsequent transaction. The subsequent transaction may be, in one example, another transaction that is yet to occur, between the first set of nodes 106 and the second set of nodes 108, following the transaction that has already occurred between the first set of nodes 106 and the second set of 108.

As the processor 112 may facilitate exchange of data and/or signals between the first and the second set of nodes, the processor 112 may be capable of determining transactions occurring between the first set of nodes 106 and the second set of nodes 108. In one example, the processor 112 may include a transaction analysis and prediction unit 308 that may track one or more transactions occurring between the first set of nodes 106 and the second set of nodes 108. Based on the tracking, the transaction analysis and prediction unit 308 may be aware of the transaction occurring between the first set of nodes 106 and the second set of nodes 108.

Based on the transaction, the transaction analysis and prediction unit 308 may be capable of predicting the subsequent transactions that may probably occur after the transaction that has recently occurred. In one example, the prediction may based on at least a sequence of occurrence of one or more previous transactions between the first set of nodes 106 and the second set of nodes 108. The transaction analysis and prediction unit 308 may utilize, in one example, a trained machine learning model for predicting the subsequent transaction and the attribute associated with the data 110 to be communicated in the subsequent transaction. The machine learning model may be trained with data sets indicating transactions that generally occur between the first set of nodes 106 and the second set of nodes 108 and an attribute associated with data involved in such transactions. The attribute may be, for example, a property or characteristic of the data involved in such transactions. Examples of the attribute may include, but are not limited to, size and type of data involved in such transactions. Further, the machine learning model may be trained with data sets indicating a pattern or sequence in which such transactions mostly occur between the first set of nodes 106 and the second set of nodes 108. Thus, a machine learning model may be configured or trained with data sets indicating most of the possible transactions and a sequence in which they generally occur. Such a trained machine learning model may be deployed and utilized by the processor 112, or the transaction analysis and prediction unit 308, for predicting the subsequent transactions that may probably occur after a transaction has occurred, and the attribute associated with the data, such as the data 110, that is yet to be communicated in the subsequent transaction.

Further, the machine learning model may be dynamically trained based on the requirements of the computing environment or the purpose for which it may be deployed. For example, the data set that may be used for training the machine learning model may be changed based on the scenario or environment it is deployed. For example, if the machine learning model is to be deployed in the aircraft service-related computing environment, the data set indicating possible transactions, attributes associated with the data involved in such transactions, and sequence in which such transactions generally occur in the aircraft service-related computing environment may be used for training the machine learning model. However, if the machine learning model is to be deployed in the OTT service-related computing environment, the data set indicating possible transactions, attributes associated with the data involved in such transactions, and the sequence in which such transactions generally occur in the OTT service-related computing environment may be used for training the machine learning model. Thus, the processor 112 may flexibly be utilized for dynamically predicting transactions and attributes associated with the data involved in such transactions for different computing environments.

In one example, the trained machine learning model may be deployed in the system 102 and communicably coupled with the processor 112 or the transaction analysis and prediction unit 308 of the processor 112. In this example, the trained machine learning model may provide an indication to the processor 112, or the transaction analysis and prediction unit 308, about the subsequent transaction and the attribute associated with the data 110 associated with the subsequent transaction. In another example, the trained machine learning model may be integrated with the processor 112, or transaction analysis and prediction unit 308.

Utilization of machine learning model has been discussed above for predicting the subsequent transaction and attribute associated with the data involved in such transactions. However, it may be possible that different approaches may be adopted for achieving predictions. For example, an Artificial Intelligence (AI) model may be trained and utilized for predicting the subsequent transaction and attributes. Alternatively, a deep learning model or a neural network may be configured and utilized for predicting the subsequent transaction and the attributes. Similarly, other possible approaches may also be utilized.

Thus, in one example, the processor 112 may predict the occurrence of the subsequent transaction in response to the occurrence of a transaction between the first set of nodes 106 and the second set of nodes 108. Further, upon predicting the subsequent transaction, the processor 112 may determine the attribute associated with data linked with the subsequent transaction. For exemplary purposes, it may be considered hereinafter that the subsequent transaction is a transaction in which the second set of nodes 108 is to send the data 110 to the first set of nodes 106. Examples of the data 110 may include, but are not limited to, text, one or more images, videos, signals, and metadata related to any other transaction.

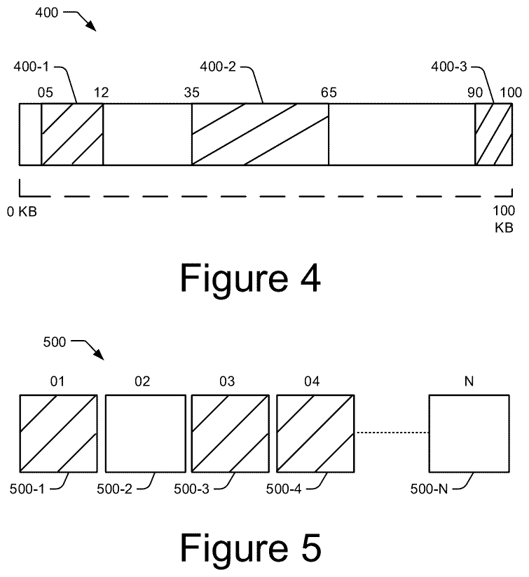

Once the attribute associated with the data 110 to be communicated from the second set of nodes 108 to the first set of nodes 106, the processor 112 may translate the attribute into the divisible form made of the plurality of discretized elements that collectively represent the attribute. The divisible form may be, for example, the numerical representation or depiction of the attribute. In one example, the processor 112 may include a data identification unit 310 that may translate the attribute into the numeral representation or value corresponding to the attribute. For example, consider that the processor 112 determined that the data 110 associated with the subsequent transaction is a text message having size of 100 KB. Here, the attributes may be “100 KB” and “text”. FIG. 4 illustrates the data 110 as textual data 400, according to one example implementation. The textual data 400 may be, in one example, a serial text data having the size of 100 KB. The textual data may serially extend from 0 KB to 100 KB, as illustrated in FIG. 4. The processor 112, or the data identification unit 310, may derive the numerical representation of the attribute “100 KB” as “100”, i.e., the divisible form.

Further, the discretized elements may be elements derived by breaking down the divisible form. In one example, the discretized elements may be derived by dividing the divisible form such that computational complexity may be reduced. For example, the discretized elements may be derived by breaking down the divisible form so that natural numbers may be received. That is, the derivation may be such that complex and or integer numerical values are not obtained. Such discretized elements may simplify the further processing and/or computations. Considering the above example where the attribute is translated into divisible form “100”, the discretized elements may be, for example, 0, 1, 2, 3, 5, . . . 100. The discretized elements may thus collectively represent the divisible form and thereby the attribute.

In another example, consider that the processor 112 determined that the data 110 associated with the subsequent transaction is a set of frames or images having 10 frames or images. Here, the attributes may be the number of images “10” and the characteristics of the data 110 as “image”. FIG. 5 illustrates the data 110 as a set of images 500, according to one example implementation. The set of images 500 may have 10 images arranged in an ordered manner. For example, a 1st image 500-1 may be located first, followed by a 2^{nd} image 500-2 . . . till N^{th} image, where N is a natural number. In this example, N may be equal to 10. The processor 112, or the data identification unit 310, may derive the numerical representation from the attribute as “10” images as “10”, i.e., the divisible form. Considering the above example where the attribute is translated into divisible form “10”, the discretized elements may be 1, 2, 3, 4, . . . 10. The discretized elements may thus collectively represent the divisible form “10” and thereby the attribute number of images.

Further, in addition to reducing processing or computational complexity, the discretized elements may also be determined by considering the determined attribute. For example, by determining the attribute indicating characteristics of the data 110 as “image”, the processor 112 may be configured to refrain from deriving the discretized elements that may not be appropriate or preferable for image type of data. For example, if the processor 112 determined that the data 110 comprises the set of images 500, the discretized element such as “5.5” may be avoided from being derived. Instead, by having knowledge of the characteristics of data, the processor 112 may be configured to derive a simplified discretized element, such as “6” which is preferable for the image type of data as “5.5” may represent half portion of the 6th image. Instead, having known the fact that the data 110 is a set of images the processor 110 may derive the next simpler discretized element (for example, 6 instead of 5.5). Thus, in one example, based on the determined attribute, appropriate or preferable discretized elements may be derived that may reduce computational complexity and, at the same time, represent appropriate portions of the data, as discussed above and will be discussed below.

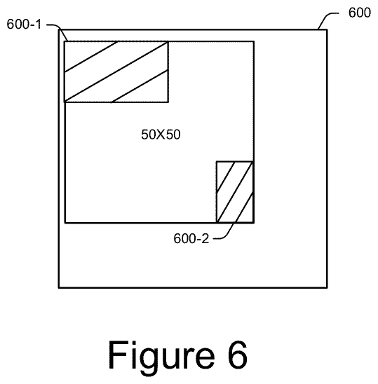

In yet another example, consider that the processor 112 determined that the data 110 associated with the subsequent transaction is an image having a specific format. For example, the data 110 may be an image having Joint Photographic Experts Group (JPEG) format. Here, the attributes may be the type of data “image” and the format of the data “JPEG”. FIG. 6 illustrates the data 110 as an image 600, according to one example implementation. Based on the attributes, the processor 112 may determine the divisible form. For example, in the scenario where no numerical characteristics may be indicated in the attribute, such as the exemplary attribute “JPEG”, the processor 112 may be configured to translate the attribute to derive a divisible form. In one example, the processor 112 may be configured to determine a minimum possible resolution for the attribute indicating “image” or “JPEG” if no numerical characteristics may be indicated in the attribute. That is, the processor 112 may translate the attribute “image” or “JPEG” into the divisible form indicating the minimum possible resolution of data 110, i.e., the image 600. For exemplary purposes, consider the minimum possible resolution to be 50×50 for the image 600, as illustrated in FIG. 6. The divisible form may be determined to be “50×50”. Considering the above example where the attribute is translated into the divisible form “50×50”, the discretized elements may be multiple resolution blocks, each identifying 10×10 resolution of the image 600 such that they collectively represent the divisible form “50×50” and thereby the attribute.

Further, each of the discretized element identifies a portion of the data 110. For example, considering the textual data 400, each of the discretized elements 1, 2, 3 . . . 100 may identify a data point in the textual data 400. For example, the discretized element 1 may identify portion of the textual data 400 located between data points 0 KB to 1 KB and the discretized element 2 may identify portion of the textual data 400 located between data points 1 KB to 2 KB. Similarly, all the discretized elements may identify a corresponding portion of the data 110, and, in this case, the textual data 400.

Considering the example of the set of images 500, each of the discretized elements 1, 2, 3, . . . 10 may identify a specific image from the set of images 500. For example, the discretized element 1 may identify the 1^{st} image 500-1, the discretized element 2 may identify the 2^{nd} image 500-2. Similarly, all the discretized elements may identify a corresponding portion of the data 110, and, in this case, the set of images 500. Considering another example of the image 600, each of the discretized elements (i.e., each 10×10 block) may indentify a specific portion of the image 600.

Further, divisible forms and discretized elements may be derived for other types and characteristics of data, for example, in a similar manner.

Though it has been discussed that the processor 112 may predict the data 110 associated with the subsequent transaction and the attribute associated with the data 110, however, it is also possible that the processor 112 may only determine the attribute associated with the data 110. As discussed above, the processor 112, or the transaction analysis and prediction unit 308, may be trained similarly to predict or determine only the attribute associated with the data 110 linked with the subsequent of upcoming transaction. Thus, once the processor 112 determines or predicts the attribute associated with the data 110 linked with the subsequent transaction, the processor 112, or the data identification unit 310, may translate the determined attribute into the divisible form. In one example, the divisible form may be made of the plurality of discretized elements that may collectively represent the attribute and each of the discretized elements identifies a portion of the data 110.

Further, the processor 112 may determine one or more discretized elements from amongst the plurality of discretized elements. In one example, the processor 112, or the data identification unit 310, may determine the one or more discretized elements based on the random selection mechanism. For example, the processor 112 may randomly select the discretized elements from amongst the plurality of discretized elements without any specific selection pattern or bias or any selection logic or criteria. Each of the plurality of discretized elements may have an equal chance or probability of being selected, thereby minimizing predictiveness and bias in selection. Examples of the random selection mechanism may include, but are not limited to, simple random sampling and complex random sampling. Further, the random selection mechanism is straightforward to implement and may generally not involve the execution of complex computation processes, thereby avoiding the consumption of too many computational resources. Furthermore, the random selection mechanism is flexible in nature and can be applied to various types of data, making it a versatile approach.

By implementing the random selection mechanism, the processor 112 may randomly determine one or more discretized elements from amongst the plurality of discretized elements. For example, considering the textual data 400, the randomly determined one or more discretized elements may be 05 to 12, 35 to 65, and 90 to 100, as illustrated in FIG. 4. Each of the discretized elements may identify a corresponding portion of the data, that is the textual data 400. For example, the range of discretized elements 05 to 12 may identify the portion 400-1 of the textual data 400, the range of discretized elements 35 to 65 may identify the portion 400-2 of the textual data 400, and the range of discretized elements 90 to 100 may identify the portion 400-3 of the textual data 400.

In another example, considering the set of images 500, the randomly determined one or more discretized elements may be 500-1, 500-3, and 500-4, as illustrated in FIG. 5. In yet another example, considering the image 600, the randomly determined one or more discretized elements may identify blocks 600-1 and 600-2 of the image 600. The blocks 600-1 and 600-2 may have a resolution such that they may identify at least one-third of the resolution of the image 600.

In one example, the processor 112, or the data identification unit 310, may determine the one or more discretized elements to collectively represent a fraction of the plurality of discretized elements. For example, the processor 112 may determine the one or more discretized elements to collectively represent the fraction that may be more than a threshold fraction. In one example, the threshold fraction may be a fraction of minimum required number of discrete elements and the total number of discrete elements. For example, the threshold fraction may be one-third of the total number of discretized elements. For example, considering the textual data 400, the threshold fraction may be at least 34 out of 100 discretized elements. In another example, considering the set of images 500, the threshold fraction may be at least 4 out of 10 discretized elements. In yet another example, considering the image 600, the threshold fraction may be at least one or more blocks that may collectively represent at least 20×20 out of 50×50 discretized elements. Further, if a single discretized element satisfies the minimum requirement of the threshold fraction, no further discretized elements may be selected from amongst the plurality of discretized elements. For example, if a single block sufficiently represents one-third of the image 600, no more additional discretized elements may be selected.

The threshold fraction may thus indicate a minimum quantized representation or number of discretized elements that need to be determined. In one example, the threshold fraction may be dynamically modified to determine modified minimum number of discretized elements. In one example, if more discretized elements are required to be determined from amongst the plurality of discretized elements, the threshold fraction may be increased. For example, the threshold fraction may be modified to two-thirds, instead of one-third, of the total discretized elements.

Once the one or more discretized elements are selected or determined from amongst the plurality of discretized elements, the processor 112, or the data identification unit 310, may generate a portion identification signal based on the one or more discretized elements to identify one or more portions of the data which is yet to be communicated to at least one of the first set of nodes 106 and the second set of nodes 108. For example, the processor 112 may generate the portion identification signal indicating the portions of the data identified by the one or more determined discrete elements. For example, considering the textual data 400, the processor 112 may generate the portion identification signal that may contain information indicating the portions 400-1, 400-2, and 400-3 being identified by the determined discretized elements. In another example of the set of images 500, the processor 112 may generate the portion identification signal that may contain information indicating the portions 500-1, 500-3, and 500-4 being identified by the determined discretized elements. In yet another example of the image 600, the processor 112 may generate the portion identification signal that may contain information indicating the blocks 600-1 and 600-2 identified by the determined discretized elements.

Thus, each of the determined one or more discretized elements may identify a portion of the data 110. Accordingly, the processor 112 may be configured to generate the portion identification signal that may contain information identifying the one or more portions of the data based on the determined discretized elements. In one example, the portion identification signal may be generated by the data identification unit 310. Further, the identified portions of the data 110 is yet to be communicated to the processor 112 in the transaction yet to occur, i.e., the subsequent transaction, from the second set of nodes 108 to the first set of nodes 106. Thus, once the one or more discretized elements are randomly determined, the processor 112 may generate the portion identification signal identifying the portions of the data 110 corresponding to the determined one or more discretized elements.

Further, by generating the portion identification signal, the processor 112 may trigger association of a digital credential with each of the one or more identified portions of the data 110 yet to be communicated. For example, the processor 112 may trigger a workflow that may be configured to associate a digital credential with each of the one or more identified portions of the data. In one example, the digital credential may be a digital signature. The processor 112 may cause association, for example, of a unique digital signature with each of the one or more identified portions, i.e., the identified images from amongst the set of images 500. In another example, same digital certificate may be associated with each of the one or more identified images.

In one example, by generating the portion identification signal, the processor 112 may trigger the node, which intends to send the data 110, to associate the digital credential, for the data 110 to be authenticated and, subsequently, transferred to other node(s). As the intending node is sender of the data 110, the processor 110 may trigger the intending node to associate the digital credentials for verification of the data 110. For example, by generating the portion identification signal, the processor 112 may trigger the second set of nodes 108, which intends to send the data 110 to the first set of nodes 106, to associate the digital credential with the one or more portions of the data 110 identified by the discretized elements. Examples of digital credentials may include, but are not limited to, digital signatures and key encryption techniques. In one example, the digital credentials may be generated and associated with the portions of the data 110 using any of the known approaches. The processor 112 may then, in one example, receive the data 110, including the one or more portions of the data 110 associated with the digital credentials.

Further, the processor 112 may determine an authentication status for each of the one or more identified portions of the data based on the digital credential associated therewith. In one example, the processor 112 may include a data authentication unit 312 that may be configured to receive the data 110 and determine the authentication status. For example, the data authentication unit 312 may verify the digital credentials associated with each of the one or more portions of the data 110 by implementing any known process. For example, the data authentication unit 312 may implement a cryptography-based process to verify the digital credentials associated with each of the one or more portions of the data 110. Based on the verification of the digital signatures or credentials, the processor 112, or the data authentication unit 312, may determine the authentication status for each of the one or more identified portions of the data 110.

In one example, the authentication status may indicate whether each of the one or more identified portions of the data 110 complies with the data integrity requirement. For example, if the digital credential associated with each of the one or more identified portions of the data 110 is determined to indicate that the one or more identified portions are from an authentic or authorized source, being one of the data integrity requirements. The processor 112 may thereby determine that each of the one or more identified portions of the data 110 is allowable, being the authentication status. Thus, the authentication status may indicate whether each of the one or more identified portions of the data is allowable.

Based on the authentication status of each of the one or more identified portions of the data, the processor 112 may determine whether occurrence of the subsequent transaction between at least one of the first set of nodes 106 and the second set of nodes 108 is to be permitted. For example, if the digital credentials associated with the one or more identified portions of the data 110 are determined to be allowable, the processor 112 may permit communication of the data 110 associated with the subsequent transaction. For instance, communication of the data 110 may be permitted from the second set of nodes 108 to the first set of nodes 106.

In response to permitting occurrence of the subsequent transaction, the processor 112 or the data authentication unit 312 may generate a positive acknowledgment indicator indicating that the data 110 complies with the data integrity requirement. The processor 112 or the data authentication unit 312 may then trigger storage of the positive acknowledgment indicator to record compliance of the data 110. In one example, the positive acknowledgement indicator may be stored in the storage unit(s) 302 to record that the data 110 complied with the data integrity requirements. In one example, such records may be analyzed by the processor 112 or the transaction analysis and prediction unit 308 in order to learn or train themselves for similar data from similar sources in further transactions, so that the further data may be analyzed and authenticated in a faster manner.

However, if the processor 112, or the data authentication unit 312, determines that the digital credentials associated with any of the one or more identified portions of the data 110 fail to comply with the data integrity requirement, the processor 112 may determine an authentication status indicating the non-allowability of the data 110. The processor 112, based on the authentication status, may prohibit occurrence of the subsequent transaction between the first set of nodes 106 and the second set of nodes 108.

In response to prohibiting the subsequent transaction, the processor 112 or the data authentication unit 312 may generate a negative acknowledgement indicator to indicate that data 110 fails to comply with the data integrity requirement. In one example, the negative acknowledgement indicator may be stored in the storage unit(s) 302 to record that the data 110 failed to comply with the data integrity requirement. In one example, such records may be analyzed by the processor 112 or the transaction analysis and prediction unit 308 to learn or train themselves for similar data from similar sources in further transactions, so that transfer of further similar data from similar nodes may be restricted or authenticated more severely.

In one example, the processor 112 may also be configured to generate a visual alert, an audio alert, or a combination thereof to indicate failure of the subsequent transaction. In one example, the alert may be provided to any external device communicably coupled with the processor 112 or the system 102 via the interface(s).

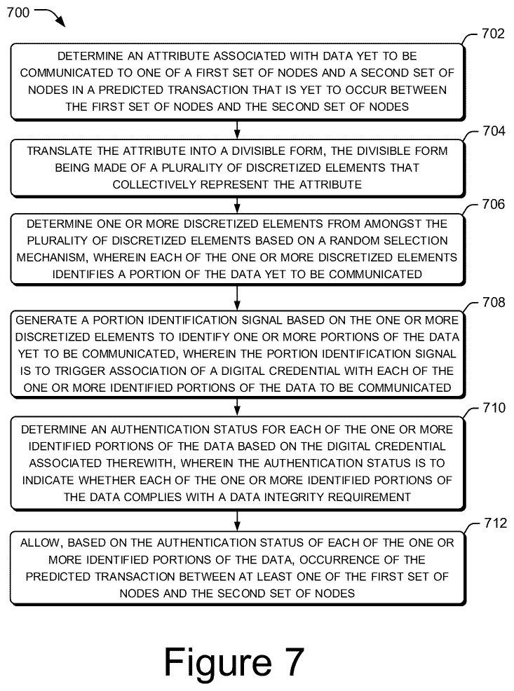

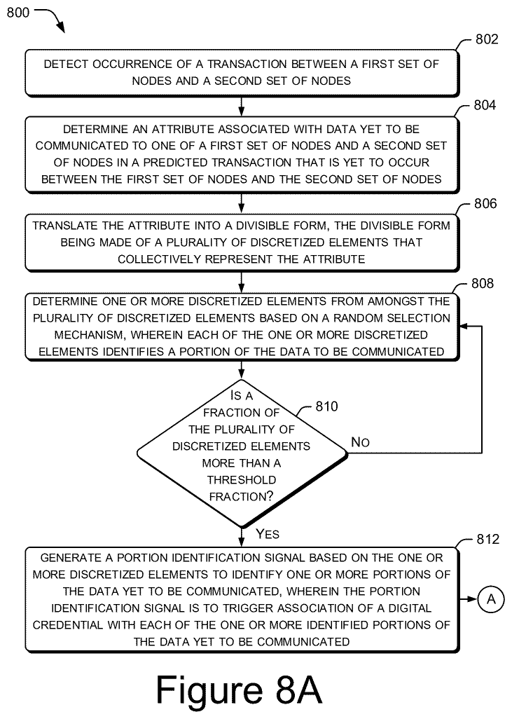

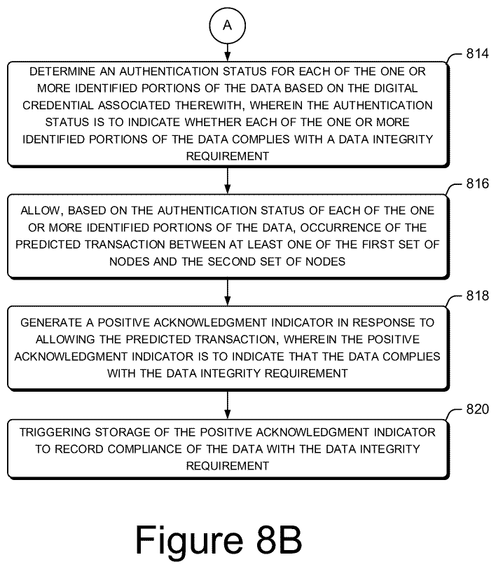

FIGS. 7 to 8B illustrate exemplary methods 700 and 800, respectively, for managing network transactions with enhanced security. The order in which the methods are described is not intended to be construed as a limitation, and any number of the described method blocks may be combined in any order to implement the methods, or an alternative method. Furthermore, methods 700 and 800 may be implemented by processing resource or computing device(s) through any suitable hardware, non-transitory machine-readable instructions, or combination thereof.

It may also be understood that methods 700 and 800 may be performed by programmed computing devices, such as the processor 112, as depicted in FIGS. 1A-4. Furthermore, the methods 700 and 800 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. While the methods 700 and 800 are described below with reference to the processor 112 and the system 102 as described above; other suitable systems for the execution of these methods may also be utilized. Additionally, implementation of these methods is not limited to such examples.

FIG. 7 illustrates the method 700 for managing network transactions, according to an example implementation.

At block 702, an attribute associated with data yet to be communicated to one of a first set of nodes and a second set of nodes may be determined. In one example, the attribute may be a characteristic associated with the data, such as the data 110, that may be communicated in a predicted transaction that is yet to occur between the first set of nodes, such as the first set of nodes 106, and the second set of nodes, such as the second set of nodes 108.

At block 704, the attribute may be translated into a divisible form. In one example, the divisible form may be a numerical depiction corresponding to the determined attribute. The divisible form may be made of a plurality of discretized elements that collectively represent the attribute. For example, the numerical depiction may be broken down to determine the plurality of discretized elements that may collectively represent the divisible form, and thereby the attribute.

At block 706, one or more discretized elements from amongst the plurality of discretized elements may be determined. In one example, the one or more discretized elements may be determined based on a random selection mechanism. Further, each of the one or more discretized elements may identify a portion of the data 110 yet to be communicated.

At block 708, a portion identification signal may be generated based on the one or more discretized elements to identify one or more portions of the data 110 yet to be communicated. In one example, the portion identification signal may include information indicating the one or more portions of the data 110 identified by the one or more discretized elements. Further, the portion identification signal may trigger association of a digital credential with each of the one or more identified portions of the data 110 which is yet to be communicated to the first and the second set of nodes. In one example, the digital credential may be a digital signature that may be associated with each of the one or more identified portions of the data 110.

At block 710, an authentication status for each of the one or more identified portions of the data 110 may be determined. In one example, the authentication status may be determined based on the digital credentials associated therewith. For example, the digital signature may be validated to determine whether the one or more portions of the data are allowable or non-allowable. The authentication status may indicate whether each of the one or more identified portions of the data complies with a data integrity requirement. If the digital credentials associated with each of the one or more portions of the data 110 comply with the data integrity requirement, it may be ascertained that the data 110 may be safe for communication, for example, from the second set of nodes 108 to the first set of nodes 106. However, if the digital credentials associated with any of the one or more portions of the data 110 fails to comply with the data integrity requirement, it may be ascertained that the data 110 may be unsafe for communication, for example, from the second set of nodes 108 to the first set of nodes 106. In one example, safe and unsafe may be the authentication status. However, other indications may also be possible.

At block 712, occurrence of the predicted transaction between at least one of the first set of nodes and the second set of nodes may be allowed. In one example, occurrence of the predicted transaction may be allowed based on the authentication status of each of the one or more identified portions of the data 110. For example, if the authentication status indicates that the data 110 is safe for communication, the predicted transaction may be allowed. The data 110 may thus be allowed, for example, to be transferred from the second set of nodes 108 to the first set of nodes 106.

However, if the authentication status indicates that the data 110 is unsafe for communication, the predicted transaction may be prohibited. Transfer of the data 110 may thus not be allowed, for example, from the second set of nodes 108 to the first set of nodes 106.

FIGS. 8A and 8B illustrate the method 800 for managing the network transactions, according to another example implementation.

At block 802, occurrence of a transaction between a first set of nodes and a second set of node may be detected. In one example, transactions between the first set of nodes, such as the first set of nodes 106, and the second set of nodes, such as the second set of nodes 108, may be monitored to detect occurrence of the transaction therebetween. For example, the transaction may be transmission of data and/or signals from the first set of nodes 106 to the second set of nodes 108. For example, as the first set of nodes 106 and the second set of nodes 108 may be communicably coupled via the processor 112, or at least the system 102, the processor may be capable of monitoring and detecting the transaction.

At block 804, an attribute associated with data yet to be communicated to one of the first set of nodes and the second set of nodes may be determined. In one example, the attribute may be a characteristic associated with the data, such as the data 110, that may be communicated in a predicted transaction that is yet to occur between the first set of nodes 106 and the second set of nodes 108. In one example, the attribute may be determined in response to detecting occurrence of the transaction between the first set of nodes 106 and the second set of nodes 108, where the detected transaction is a transaction occurring before the predicted transaction. That is, based on the detected transaction, occurrence of the predicted transaction, that is going to occur between the first set of nodes and the second set of nodes after the detected transaction, may be estimated. In response to occurrence of the detected transaction, an attribute associated with the data 110 yet to be communicated in the subsequent transaction, herein referred to as the predicted transaction, may be determined. In one example, the predicted transaction may be estimated based on at least a sequence of occurrence of one or more previous transactions between the first set of nodes 106 and the second set of nodes 108. Thus, the attribute may also be accordingly determined based on the attributes associated with the previous transactions.

At block 806, the attribute may be translated into a divisible form. The divisible form may be made of a plurality of discretized elements that may collectively represent the attribute. The divisible form may be, for example, a numerical representation or depiction of the attribute. Further, the plurality of discretized elements may be elements derived by breaking down the divisible form, as discussed above with reference to FIGS. 3 to 6.

For example, the data 110 associated with the predicted transaction may be a video having a set of frames, say, 10 frames. Here, the attributes may be the number of frames. The attribute may be translated into the divisible form, i.e., a numerical depiction of the attribute. Thus, the divisible form may be “10” based on the attribute (number of frames). Further, the frames may be serially ordered, for example, based on their time stamp in the video. For example, a 1^{st} frame may be arranged at first place, followed by a 2^{nd} frame 500-2 . . . till N^{th} frame, i.e., the last frame of the video. In this example, N may be equal to 10. Further, the discretized elements may be 1, 2, 3, 4, . . . 10, each identifying the respective frame. For example, the discretized element 1 may identify the 1^{st} frame, the discretized element 2 may identify the 2^{nd} frame, . . . and the discretized element N may identify the 10^{th} frame. The discretized elements may thus collectively represent the divisible form “10” and thereby the attribute number of frames. Further, each of the one or more discretized elements may identify a portion of the data 110, such as the respective frame, yet to be communicated in the predicted transaction.

At block 808, one or more discretized elements from amongst the plurality of discretized elements may be determined. In one example, the one or more discretized elements may be determined based on the random selection mechanism. For example, the one or more discretized elements, from amongst the plurality of discretized elements, may be determined without any specific selection pattern or logic. Considering the above example of set of 10 frames, any of the discretized elements 1 to 10 may be randomly selected, where each of the discretized elements identifies respective frames from amongst the set of frames. For example, discretized elements 1, 2, 4, 6, and 7 may be determined. The discretized elements may correspond to respective frames-1st frame, 2nd frame, 4th frame, 6th frame, and 7th frame from the set of frames.

At block 810, it may be determined whether a fraction of the plurality of discretized elements more than a threshold fraction. In one example, as the one or more discretized elements are determined from amongst the plurality of discretized elements, the one or more determined discretized elements may collectively represent a fraction of the plurality of discretized elements. For example, considering the above example of the set of frames, 5 discretized elements were randomly determined from 10 discretized elements. The fraction may thus be 5/10 or 50%. In one example, it may be determined whether a sufficient or minimum number of discretized elements, and therefore the portions of data 110 being identified by them, be determined to ensure confidence over authenticity of the data 110. The sufficient or minimum number of discretized elements may thus be defined as the threshold fraction. In one example, the threshold fraction may be 33%.

The fraction of one or more determined discretized elements and the plurality of discretized elements may be compared with the threshold fraction to determine whether a sufficient or minimum required number of discretized elements have been determined. Based on the comparison, if it is ascertained that the fraction of one or more determined discretized elements and the plurality of discretized elements is more than the threshold fraction, it may be ascertained that a sufficient or minimum required number of discretized elements have been determined. For example, the fraction 55% is more than the threshold fraction of 33%. It may thus be determined that a sufficient or minimum required number of discretized elements have been determined for verifying authenticity of the data 110. If it is ascertained that the fraction of one or more determined discretized elements and the plurality of discretized elements is more than the threshold fraction, the method may follow the Yes path to block 812.

At block 812, a portion identification signal may be generated based on the one or more discretized elements to identify one or more portions of the data 110 yet to be communicated. In one example, the portion identification signal may include information indicating the one or more portions of the data 110 identified by the one or more discretized elements. Considering the above example, for the discretized elements 1, 2, 4, 6, and 7, the identified portions of the data, i.e., the frames may be frames—1^{st} frame, 2^{nd} frame, 4^{th} frame, 6^{th} frame, and 7^{th} frame from the set of frames. Thus, each of the determined one or more discretized elements may identify a portion of the data 110.

Further, generating the portion identification signal may trigger association of a digital credential with each of the one or more identified portions of the data 110 yet to be communicated. For example, a workflow may be instructed to initiate for associating a digital credential with each of the one or more identified portions of the data. In one example, the digital credential may be a digital signature. The workflow may associate, for example, a unique digital signature with each of the one or more identified portions of the data, i.e., the identified frames from amongst the set of frames. Thus, the digital credentials may be generated and associated with the portions of the data 110. The method may then continue from block B.

From block B and at block 814, an authentication status for each of the one or more identified portions of the data may be determined based on the digital credential associated therewith. For example, the digital credentials associated with each of the one or more portions of the data 110 may be verified by implementing any known credential verification process. For example, a cryptography-based credential verification process may be initiated to verify the digital credentials associated with each of the one or more portions of the data 110. Based on the verification of the digital credentials, the authentication status for each of the one or more identified portions of the data 110 may be determined. In one example, the authentication status may indicate whether each of the one or more identified portions of the data 110 complies with the data integrity requirement. For example, if the digital credential associated with each of the one or more identified portions of the data 110 is determined to indicate that the one or more identified portions are from an authentic or authorized source, being one of the data integrity requirements. The processor 112 may thereby determine that each of the one or more identified portions of the data 110 is allowable, being the authentication status. Thus, the authentication status may indicate whether each of the one or more identified portions of the data is allowable or unallowable.

At block 816, occurrence of the predicted transaction between at least one of the first set of nodes and the second set of nodes may be allowed. In one example, occurrence of the predicted transaction may be allowed based on the authentication status of each of the one or more identified portions of the data 110. For example, if the authentication status indicates that the data 110 complies with the data integrity requirement and is allowable for communication, the predicted transaction may be allowed. The data 110 may thus be allowed, for example, to be transferred from the second set of nodes 108 to the first set of nodes 106. For example, the data 110 may be received, in response to allowance of occurrence of the predicted transaction, from one of the first set of nodes 106 and the second set of nodes 108. The data 110 may then be forwarded to other of the first set of nodes 106 and the second set of nodes 108. For instance, the data may be received, for example by the processor 112, from the second set of nodes 108 and may be forwarded to the first set of nodes 106.

At block 818, a positive acknowledgment indicator may be generated in response to allowing the predicted transaction. The positive acknowledgment indicator may indicate that the data 110 complies with the data integrity requirement.

At block 820, storage of the positive acknowledgment indicator may be triggered to record compliance of the data 110 with the data integrity requirement. The positive acknowledgment indicator may be stored, for example, in the storage unit(s) 302 to record that the data 110 complied with the data integrity requirements. The records may be analyzed, for example, in the future or for subsequent transactions, for learning or training purposes for scenarios with similar data from similar sources or nodes in further transactions, so that the further data may be analyzed and authenticated in a faster and more accurate manner.

However, if at block 816, it is determined that the authentication status indicates that the data 110 is unsafe or unallowable for communication, the predicted transaction may be restricted. Transfer of the data 110 may thus not be allowed, for example, from the second set of nodes 108 to the first set of nodes 106. In response to restricting the predicted transaction, a negative acknowledgment indicator may be generated to indicate that the data 110 fails to comply with the data integrity requirement.

Further, in one example, storage of the negative acknowledgment indicator may be triggered to record non-compliance of the data 110 associated with the predicted transaction. The negative acknowledgment indicator may be stored, for example, in the storage unit(s) 302 to record that the data 110 failed to comply with the data integrity requirement. In one example, such records may be analyzed for learning and/or training purposes for similar scenarios with similar data from similar sources in further transactions, so that transfer of further similar data from similar nodes may be restricted or authenticated more severely.

Further, if, at block 810, it is ascertained that the fraction of one or more determined discretized elements and the plurality of discretized elements is less than or equal to the threshold fraction, the method may follow the No path to block 808 to determine more discretized elements from among the plurality of discretized elements in order to improve confidence of authentication of the data. for example, if more number of discretized elements may be determined, more portion of data may be associated with digital credentials. Thus, authentication status may be determined for more portions of the data. As authentication may be performed on more portions of data, the confidence and accuracy of authentication for the complete data may improve. Further, as all of the data is not required to be associated with the digital credentials, processes of generation and authentication of digital signatures are not required to be performed for complete data. Thus, a balance of security and performance may be achieved in management of network traffic. Further, random selection of the discretized elements may lead to association of digital signatures only with limited and random portions of the data. Therefore, the security of the data as well as the digital credentials may be improved.

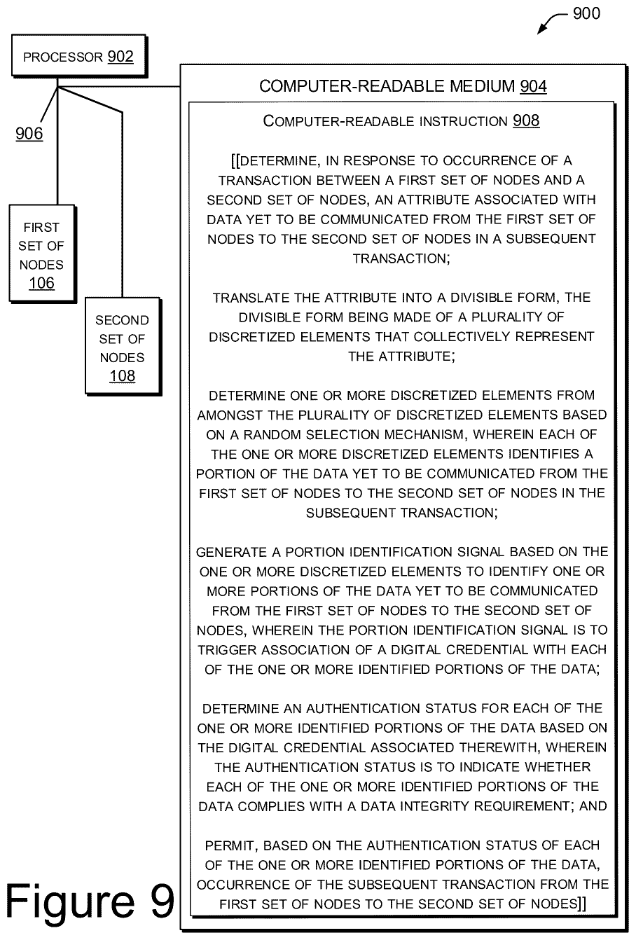

FIG. 9 illustrates a non-transitory computer-readable medium for controlling transactions within a network with enhanced security, in accordance with an example of the present subject matter.

In an example, the computing environment 900 includes a processor 902 communicatively coupled to a non-transitory computer-readable medium 904 through communication link 906. In an example, the processor 902 may have one or more processing resources for fetching and executing computer-readable instructions from the non-transitory computer-readable medium 904. The processor 902 and the non-transitory computer-readable medium 904 may be implemented, for example, in the system 102.

The non-transitory computer-readable medium 904 may be, for example, an internal memory device or an external memory. In an example implementation, the communication link 906 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer-readable medium 904 includes a set of computer-readable instructions 908 which may be accessed by the processor 902 through the communication link 906. The processor 902 and the non-transitory computer-readable medium 904 may also be communicatively coupled to the first set of nodes 106 and the second set of nodes 108 over the network communication link 906.

Referring to FIG. 9, in an example, the non-transitory computer-readable medium 804 includes computer-readable instructions 908 that may cause the processor 902 to determine, in response to occurrence of a transaction between the first set of nodes 106 and the second set of nodes 108, an attribute associated with data yet to be communicated from the first set of nodes 106 to the second set of nodes 108 in a subsequent transaction. In one example, the attribute may be predicted based on determining the transaction. That is, based on the transaction, the subsequent transaction may be determined and attribute for the data associated with the subsequent transaction may be determined. In one example, the attribute may be a property associated with the data yet to be communicated in the subsequent transaction. Further, the instructions 908 may further cause the processor 902 to translate the attribute into a divisible form. The divisible may be made of a plurality of discretized elements that collectively represent the attribute. The divisible form may be, for example, a quantitative depiction of the attribute. Further, the plurality of discretized elements may be elements derived from the divisible form, as discussed above with reference to FIGS. 3 to 6.

The instructions 908 may further cause the processor 902 to determine one or more discretized elements from amongst the plurality of discretized elements based on the random selection mechanism. For example, the one or more discretized elements, from amongst the plurality of discretized elements, may be determined without any specified selection pattern or criteria. Further, each of the one or more discretized elements may identify a portion of the data, such as the data 110, yet to be communicated from the first set of nodes 106 to the second set of nodes 108 in the subsequent transaction, as discussed above with reference to FIGS. 3 to 6. Furthermore, the determined one or more discretized elements may collectively represent a fraction of the plurality of discretized elements. In one example, the fraction may be required to be more than the threshold fraction, as discussed above. In one example, it may be determined whether a sufficient or minimum number of discretized elements, and therefore the portions of data 110 being identified by them, be determined to ensure that authenticity of the data 110 is verified for a minimum portion of the data 110. The sufficient or minimum number of discretized elements may thus be defined as the threshold fraction to determine at least a minimum portion of the data 110 for authentication.

The instructions 908 may further cause the processor 902 to generate a portion identification signal based on the one or more discretized elements to identify one or more portions of the data 110 yet to be communicated from the first set of nodes 106 to the second set of nodes 108. In one example, the portion identification signal may be a signal indicating the one or more portions of the data 110 being identifiable by the one or more determined discretized elements. Thus, each of the determined one or more discretized elements may identify at least one portion of the data 110.

Further, generating the portion identification signal may trigger association of a digital credential with each of the one or more identified portions of the data 110 yet to be communicated. For example, a set of instructions may be executed to initiate association of a digital credential with each of the one or more identified portions of the data 110. Execution of the instructions may cause association of a unique digital credential with each of the one or more identified portions of the data 110. Thus, the digital credentials may be generated and associated with the portions of the data 110.

The instructions 908 may further cause the processor 902 to determine an authentication status for each of the one or more identified portions of the data 110 based on the digital credential associated therewith. For example, the digital credentials associated with each of the one or more portions of the data 110 may be checked for verification. Based on the verification of the digital credentials, the authentication status for each of the one or more identified portions of the data 110 may be determined. The authentication status may indicate whether each of the one or more identified portions of the data complies with a data integrity requirement or policy. The data integrity requirement or policy may be a set of rules or guidelines, in one example, required to be complied with the digital credentials. In another example, the data integrity requirement or policy may include a list of authorized sources for the data 110. Similarly, other rules may be flexibly defined and implemented based on the requirements.

For example, if the digital credential associated with each of the one or more identified portions of the data 110 is determined to indicate that the one or more identified portions are from an acceptable and/or recognized source, being one of the data integrity requirements, the data 110 may be determined to be from the accepted or recognized source. The processor 112 may thereby determine that each of the one or more identified portions of the data 110 is allowable. Thus, the authentication status may indicate whether each of the one or more identified portions of the data 110 is allowable or unallowable.

The instructions 908 may further cause the processor 902 to permit occurrence of the subsequent transaction between from the first set of nodes 106 to the second set of nodes 108. In one example, occurrence of the subsequent transaction may be allowed based on the authentication status of each of the one or more identified portions of the data 110. For example, if the authentication status indicates that the data 110 complies with the data integrity requirement, the subsequent transaction may be allowed. The data 110 may thus be allowed, for example, to be transferred from the first set of nodes 106 to the second set of nodes 108. For example, the data 110 may be received by the processor 902, in response to permitting of occurrence of the subsequent transaction, from the first set of nodes 106 to the second set of nodes 108. The data 110 may then be forwarded by the processor 02, or the system 102, to the second set of nodes 108.

The instructions 908 may further cause the processor 902 to generate a positive acknowledgment indicator in response to permitting of the subsequent transaction. The positive acknowledgment indicator may indicate that the data 110 complies with the data integrity requirement. The instructions 908 may further cause the processor 902 to trigger storage of the positive acknowledgment indicator to record compliance of the data 110 with the data integrity requirement. The positive acknowledgment indicator may be stored, for example, in the storage unit(s) 302 to record that the data 110 complied with the data integrity requirements. The records may be analyzed, for example, for subsequent transactions, for learning or training purposes for scenarios with similar data from similar nodes, so that the authentication of similar data from similar nodes may require less time and processing.

However, if it is determined based on the authentication status that the data 110 is unallowable for communication, the instructions 908 may further cause the processor 902 to deny occurrence the subsequent transaction. Transfer of the data 110 may thus not be allowed from the first set of nodes 106 to the second set of nodes 108.

The instructions 908 may further cause the processor 902 to generate a negative acknowledgment indicator in response to determining to deny occurrence of the subsequent transaction. The negative acknowledgment indicator may indicate that the data 110 fails to comply with the data integrity requirement. The instructions 908 may further cause the processor 902 to trigger storage of the negative acknowledgment indicator to record non-compliance of the data 110 associated with the subsequent transaction. The negative acknowledgment indicator may be stored, for example, in the storage unit(s) 302 to record that the data 110 failed to comply with the data integrity requirement. In one example, such records may be analyzed for learning and/or training purposes for similar scenarios with similar data from similar sources in further transactions, so that transfer of further similar data from similar nodes may be denied or authenticated more severely.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system comprising:
a processor to:
determine, in response to occurrence of a transaction between a first set of nodes and a second set of nodes, an attribute associated with data to be communicated to at least one of the first set of nodes and the second set of nodes in a subsequent transaction;
translate the attribute into a divisible form, the divisible form being made of a plurality of discretized elements that collectively represent the attribute;
determine one or more discretized elements from amongst the plurality of discretized elements based on a random selection mechanism, wherein each of the one or more discretized elements identifies a portion of the data to be communicated;
generate a portion identification signal based on the one or more discretized elements to identify one or more portions of the data to be communicated to at least one of the first set of nodes and the second set of nodes, wherein the portion identification signal is to trigger association of a digital credential with each of the one or more identified portions of the data to be communicated;
determine an authentication status for each of the one or more identified portions of the data based on the digital credential associated therewith, wherein the authentication status is to indicate whether each of the one or more identified portions of the data complies with a data integrity requirement; and
permit, based on the authentication status of each of the one or more identified portions of the data, occurrence of the subsequent transaction between at least one of the first set of nodes and the second set of nodes.

2. The system of claim 1, wherein the processor is to predict the subsequent transaction yet to occur after the transaction, wherein the prediction is based on at least a sequence of occurrence of one or more previous transactions between the first set of nodes and the second set of nodes.

3. The system of claim 1, wherein the first set of nodes are associated with a first network, and wherein the second set of nodes are associated with a second network.

4. The system of claim 1, wherein the one or more discretized elements are determined to collectively represent a fraction of the plurality of discretized elements, the fraction being more than a threshold fraction.

5. The system of claim 4, wherein the fraction indicates at least one-third of the plurality of discretized elements.

6. The system of claim 1, wherein the divisible form numerically depicts the attribute associated with the data.

7. The system of claim 1, wherein the processor is to:
determine, based on the authentication status of each portion of the data, to prohibit occurrence of the subsequent transaction between the first set of nodes and the second set of nodes;
generate a negative acknowledgment indicator in response to prohibiting occurrence of the subsequent transaction, wherein the negative acknowledgment indicator is to indicate that the data fails to comply with the data integrity requirement; and
trigger storage of the negative acknowledgment indicator to record non-compliance of the data.

8. The system of claim 1, wherein the processor is to
generate a positive acknowledgment indicator in response to permitting occurrence of the subsequent transaction, wherein the positive acknowledgment indicator is to indicate that the data complies with the data integrity requirement; and
trigger storage of the positive acknowledgment indicator to record compliance of the data.

9. A method comprising:
determining an attribute associated with data yet to be communicated to one of a first set of nodes and a second set of nodes in a predicted transaction that is yet to occur between the first set of nodes and the second set of nodes;
translating the attribute into a divisible form, the divisible form being made of a plurality of discretized elements that collectively represent the attribute;
determining one or more discretized elements from amongst the plurality of discretized elements based on a random selection mechanism, wherein each of the one or more discretized elements identifies a portion of the data yet to be communicated;
generating a portion identification signal based on the one or more discretized elements to identify one or more portions of the data yet to be communicated, wherein the portion identification signal is to trigger association of a digital credential with each of the one or more identified portions of the data yet to be communicated;
determining an authentication status for each of the one or more identified portions of the data based on the digital credential associated therewith, wherein the authentication status is to indicate whether each of the one or more identified portions of the data complies with a data integrity requirement; and
allowing, based on the authentication status of each of the one or more identified portions of the data, occurrence of the predicted transaction between at least one of the first set of nodes and the second set of nodes.

10. The method of claim 9, the method further comprising:
receiving, in response to allowing occurrence of the predicted transaction, the data from one of the first set of nodes and the second set of nodes; and
forwarding the data to other of the first set of nodes and the second set of nodes.

11. The method of claim 11, the method further comprising:
detecting occurrence of a transaction between the first set of nodes and the second set of nodes, the detected transaction occurring before the predicted transaction; and
estimating, based on the detected transaction, occurrence of the predicted transaction that is going to occur between the first set of nodes and the second set of nodes after the detected transaction.

12. The method of claim 11, wherein occurrence of the predicted transaction is estimated based on at least a sequence of occurrence of one or more previous transactions between the first set of nodes and the second set of nodes.

13. The method of claim 9, wherein the determined one or more discretized elements collectively represent a fraction of the plurality of discretized elements, the fraction being more than a threshold fraction.

14. The method of claim 13, the method further comprising:
comparing the fraction with the threshold fraction; and
ascertaining, in response to the comparison, to generate the portion identification signal.

15. The method of claim 9, the method further comprising:
determining, based on the authentication status of each portion of the data, to restrict the predicted transaction between the first set of nodes and the second set of nodes;
generating a negative acknowledgment indicator in response to determining to restrict the predicted transaction, wherein the negative acknowledgment indicator is to indicate that the data fails to comply with the data integrity requirement; and
triggering storage of the negative acknowledgment indicator to record non-compliance of the data.

16. The system of claim 9, the method further comprising:
generating a positive acknowledgment indicator in response to allowing the predicted transaction, wherein the positive acknowledgment indicator is to indicate that the data complies with the data integrity requirement; and
triggering storage of the positive acknowledgment indicator to record compliance of the data with the data integrity requirement.

17. A non-transitory computer-readable medium comprising instructions being executable by a processing resource to:
determine, in response to occurrence of a transaction between a first set of nodes and a second set of nodes, an attribute associated with data yet to be communicated from the first set of nodes to the second set of nodes in a subsequent transaction;
translate the attribute into a divisible form, the divisible form being made of a plurality of discretized elements that collectively represent the attribute;
determine one or more discretized elements from amongst the plurality of discretized elements based on a random selection mechanism, wherein each of the one or more discretized elements identifies a portion of the data yet to be communicated from the first set of nodes to the second set of nodes in the subsequent transaction;
generate a portion identification signal based on the one or more discretized elements to identify one or more portions of the data yet to be communicated from the first set of nodes to the second set of nodes, wherein the portion identification signal is to trigger association of a digital credential with each of the one or more identified portions of the data;
determine an authentication status for each of the one or more identified portions of the data based on the digital credential associated therewith, wherein the authentication status is to indicate whether each of the one or more identified portions of the data complies with a data integrity requirement; and
permit, based on the authentication status of each of the one or more identified portions of the data, occurrence of the subsequent transaction from the first set of nodes to the second set of nodes.

18. The non-transitory computer-readable medium of claim 17, wherein the instructions are executed by the processing resource to:
receive, in response to permitting occurrence of the subsequent transaction, the data from the first set of nodes; and
send the data to the second set of nodes, wherein the first set of nodes are associated with a first network, and wherein the second set of nodes are associated with a second network.

19. The non-transitory computer-readable medium of claim 17, wherein the instructions are executed by the processing resource to:
determine, based on the authentication status of each portion of the data, to deny occurrence of the subsequent predicted transaction from the first set of nodes;
generate a negative acknowledgment indicator in response to determining to deny occurrence of the subsequent transaction, wherein the negative acknowledgment indicator is to indicate that the data fails to comply with the data integrity requirement; and
cause storage of the negative acknowledgment indicator to record non-compliance of the subsequent transaction.

20. The non-transitory computer-readable medium of claim 17, wherein the determined one or more discretized elements collectively represent a fraction of the plurality of discretized elements, the fraction being more than a threshold fraction.
